(19) United States
(12) Patent Application Publication
(10) Pub. No.: US 2008/0233238 A1
(43) Pub. Date: Sep. 25, 2008

(54) SUPERCRITICAL CO2 CARROT FEEDSTOCK EXTRACTION

(75) Inventors: David Roney, Bakersfield, CA (US); Brian Waibel, Kennett Square, PA (US); Rodger Marentis, Macungie, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Grimmway Enterprises, Inc., Bakersfield, CA (US)

(21) Appl. No.: 12/026,802

(22) Filed: Feb. 6, 2008

Related U.S. Application Data
(60) Provisional application No. 60/888,899, filed on Feb. 8, 2007.

(51) Int. Cl. B01D 11/04; A23P 1/00

(52) U.S. Cl. 426/50; 426/51; 426/655; 422/259

(57) ABSTRACT

The present invention provides methods for producing carrot fiber product by contacting carrot feedstock with supercritical carbon dioxide.

### CROSS-REFERENCE TO RELATED APPLICATIONS

This application claims the benefit of U.S. Provisional Application No. 60/888,899, filed on Feb. 8, 2007, the entire disclosure of which is hereby incorporated herein by reference in its entirety.

### FIELD OF THE INVENTION

This invention relates to the preparation of colorless fiber from carrot feedstock.

### BACKGROUND OF THE INVENTION

Various processes are known to extract dietary fiber from carrots. In one process, the carrots were ground, and dehydrated to produce a fiber supplement. See, Guedon, et al., Brit J Nutrition (1996) 76:51-61. However, the fiber product did not have desirable organoleptic properties. The carrot fiber was not a sugar-reduced, colorless, odorless, tasteless product suitable for fiber fortification of other food products.

A process for manufacturing a carrot fiber product with desirable organoleptic properties have been developed. See, for example, U.S. Pat. No. 6,645,546. However, this process used a bleaching process and required several hours to produce a colorless carrot fiber product.

An alternative process for producing a colorless fiber product from carrots involves extracting carotenoids using supercritical carbon dioxide (SCCO₂). Others have disclosed extracting carotenoids from carrot juice using supercritical CO₂, but do not extract carotenoids from carrot solids, for example, carrot pomace, carrot mash or carrot puree. See, for example, U.S. Pat. Nos. 5,932,101 and 6,106,720. Extraction of carotenoids from carrot solids using supercritical CO₂ has also been disclosed, but this process required using a high solvent to feedstock (e.g., carrot pomace, carrot puree, carrot mash, etc.) ratio and the addition of oil as a co-solvent. See, U.S. Patent Publication No. 2005/0266132.

There remains a need for a time and cost efficient process for producing a colorless carrot fiber product with desirable organoleptic properties that does not use caustic substances or add undesired substances (e.g., organic solvents, oils, sugars). The present invention addresses this and other needs with the development of a process for producing carrot fiber from water-saturated carrot feedstock (e.g., carrot pomace, carrot mash, carrot puree, etc.) using supercritical CO₂ to co-extract lipids (e.g. fatty acids) and carotenoids.

### BRIEF SUMMARY OF THE INVENTION

The present invention provides methods for producing a carrot raffinate having less than 0.5% of total dry weight lipid content, and upon removal of sugars in the raffinate, a substantially lipid-free carrot fiber product.

Accordingly, in a first aspect, the invention provides methods of manufacturing a substantially lipid-free carrot raffinate comprising the steps of:
a) creating a water slurry of carrot feedstock (e.g., carrot pomace, carrot mash, or carrot puree);
b) contacting the water slurry with supercritical CO₂ at a temperature of between 70-120° C. and pressure in excess of 7000 psi (483 bar), thereby extracting lipids and carotenes from the carrot feedstock; and
c) separating the CO₂ from the feedstock to yield a carrot raffinate. In some embodiments, the pressure is in excess of 7500 psi (517 bar), 8000 psi (552 bar), 8500 psi (586 bar) or 9000 psi (621 bar).

In the processes of the invention, carotenoids are co-extracted with the lipids (e.g., fatty acids). In some embodiments, at least about 25%, 30%, 40% 50%, 55%, 60%, 65%, 70%, 75%, 80%, 85%, 90%, 92% or 95% of the total carotenes are extracted from the carrot feedstock. The extracted carotenes can include alpha-carotene and beta-carotene, including all trans beta-carotene and cis beta-carotene. In some embodiments, the resulting carrot raffinate contains less than about 500 μg/g, 450 μg/g, 400 μg/g, 350 μg/g, 300 μg/g, 250 μg/g, 200 μg/g, 150 μg/g, 100 μg/g, 50 μg/g, or 25 μg/g total carotenes on a dry weight basis. In some embodiments, the resulting carrot raffinate contains less than about 450 μg/g, 400 μg/g, 350 μg/g, 300 μg/g, 250 μg/g, 200 μg/g, 150 μg/g, 100 μg/g, 50 μg/g, or 25 μg/g beta-carotenes on a dry weight basis. In some embodiments, the resulting carrot raffinate comprises less than about 1.0%, 0.8%, 0.5%, 0.2%, 0.1%, 0.05%, 0.02% total carotenes (w/w) on a dry weight basis.

In some embodiments, at least about 40% 50%, 55%, 60%, 65%, 70%, 75%, 80%, 85%, 90%, 92%, 95%, 96%, 97%, 98%, 99% or 99.5% of the total lipids are extracted from the carrot feedstock. In some embodiments, the resulting carrot raffinate comprises less than about 10%, 5%, 4%, 3%, 2%, 1%, 0.8%, 0.5%, 0.2%, 0.1% or 0.05% total lipids (w/w) on a dry weight basis.

In some embodiments, the methods comprise after step c) the further step of removing (i.e., leaching) sugars from the raffinate, thereby producing a substantially lipid-free carrot fiber product. In some embodiments, the fiber product contains less than 0.5%, 0.4%, 0.3% or 0.2% lipid content on a dry weight basis.

In some embodiments, the methods comprise after removing the sugars, the further step of drying to less than about 15%, 12%, 10%, 7%, 5% or 2% moisture or no moisture (i.e., bone dry).

In some embodiments, the methods comprise after drying the further step of reducing the particle size of the carrot fiber product to on average less than about 250 μm, 200 μm, 150 μm, or 100 μm.

In some embodiments, the methods comprise before step a) the additional step of pre-washing the carrot feedstock with water heated to least about 40° C., 50° C., 60° C., 70° C., 80° C., 90° C., 100° C., or 110° C.

In some embodiments, the methods comprise before step a) the step of pre-treating the carrot feedstock with an enzyme. In some embodiments, the enzyme is a pectinase.

In some embodiments, the carrot feedstock in the water slurry of step a) is comprised of carrot particles on average less than about 1000 μm, 900 μm, 800 μm, 700 μm, 600 μm, 500 μm, 400 μm.

In some embodiments, the water slurry of carrot feedstock of step a) comprises a ratio of water to carrot feedstock of about 4.0:1 or less, for example, 3.5:1, 3.0:1, 2.5:1, 2.0:1, 1.5:1, or 1.0:1.

In some embodiments, the water slurry of carrot feedstock is heated to at least about 50° C., 60° C., 70° C., 80° C., 90° C., 100° C., or 110° C.

The extraction process can be continuous or discontinuous.

In some embodiments, the contacting step b) is carried out in a batch process. In some embodiments, the contacting step b) is carried out in a batch-continuous process.

In some embodiments, the contacting step b) is carried out in a countercurrent column process. In some embodiments, the column process uses no stationary phase packing, and the countercurrent flow of the water and carrot feedstock in the carrot feedstock slurry can act as packing. In some embodiments, the countercurrent column process uses a stationary phase packing that allows the passage of the carrot feedstock without clogging.

In some embodiments, the column is about 5-100 feet in length, for example about 5, 6, 7, 8, 9, 10, 15, 20, 25, 30, 35, 40, 45, 50, 55, 60, 70, 75, 80, 90 or 100 feet in length.

In some embodiments, the lipids and carotenes are extracted in less than about 10-15 minutes, for example, about 10, 11, 12, 13, 14 or 15 minutes of exposure to supercritical CO₂.

In some embodiments, the ratio of supercritical CO₂ solvent to carrot feedstock is about 5:1 or less, for example, about 5.0:1, 4.5:1, 4.0:1, 3.5:1, 3.0:1 2.5:1, 2.0:1, 1.8:1, 1.5:1, 1.3:1, 1.0:1, 0.5:1, or less.

In some embodiments, the proportion of the supercritical CO₂ solvent to water is between about 40-60%, for example about 50% (i.e., 1:1 ratio) by weight based on the total weight.

### DEFINITIONS

The term “water slurry” refers to a composition comprising carrot feedstock in an aqueous solution comprising at least 50% water. In some embodiments, the slurry can contain an organic solvent, for example, a lower alkyl alcohol or an oil.

The terms “feedstock” and “carrot feedstock” interchangeably refer to the carrot material that is subjected to the extraction processes described herein. The feedstock can contain endogenous fluids (e.g., can be carrot cuttings, peelings, puree) or have the endogenous fluids removed (e.g., carrot pomace, carrot mash). The feedstock can be cooked or uncooked. The feedstock may or may not be subject to freezing and/or drying. The feedstock of the present invention contains carrot solids.

The term “carrot puree” refers to carrot material that has been subject to grinding and containing particles of about ¼ inch or less in diameter. Carrot juice may or may not be extracted from carrot puree. Carrot puree may or may not contain peelings. Carrot puree can be cooked (e.g., blanched) or uncooked.

The term “carrot pomace” refers to the solid residual product from carrot puree after the carrot juice has been extracted. Carrot pomace can be cooked (e.g., blanched) or uncooked (e.g., carrot mash).

The term “carrot raffinate” refers to the carrot product discharged from the bottom of the countercurrent column or retained in the container after extraction by batch processing.

The term “fiber product” refers to carrot material that has been extracted with supercritical carbon dioxide to be substantially lipid-free and substantially carotene-free, and leached with water to be sugar-reduced.

The terms “carotenes” or “carotenoids” interchangeably refer to terpene compounds providing orange pigmentation to the carrot material. Total carotenes include alpha-carotenes, beta-carotenes (cis and trans), gamma-carotenes and zeta-carotenes, particularly alpha-carotenes and beta-carotenes (cis and trans).

The term “lipid” refers to fats and fatlike compounds, including sterols, fatty acids, and triglycerides.

The term “sugar-reduced” refers to carrot material that has less than the naturally-occurring weight percent (w/w) of sugars. Depending on the level of sugar removal (e.g., leaching), the sugar content of sugar-reduced carrot material can be considered high or low. High content sugar-reduced carrot material has at least about 50% of the naturally occurring total sugar content removed. Low content sugar-reduced carrot material has at least about 80% of the naturally occurring total sugar content removed. In some embodiments, the sugar-reduced carrot material is substantially sugar-free, and at least about 95% of the naturally occurring total sugar content is removed.

The term “dry weight” refers to total weight of solids after all moisture has been removed (bone dry).

The term “continuous phase” refers to the substance that fills at least 90% of the volume of a column in a connected tridimensional space.

The term “discontinuous phase” refers to the substance that fills less than 10% of the volume of a column in a disconnected tridimensional space.

The term “solvent” refers to a liquid substance capable of dissolving another substance (i.e., a solute). In the present invention, carotenes and lipids are extracted in a supercritical CO₂ solvent.

### BRIEF DESCRIPTION OF THE DRAWINGS

FIG. 1 illustrates a schematic of a countercurrent column process. The flow of the carrot feedstock and the supercritical CO₂ are in opposite directions.

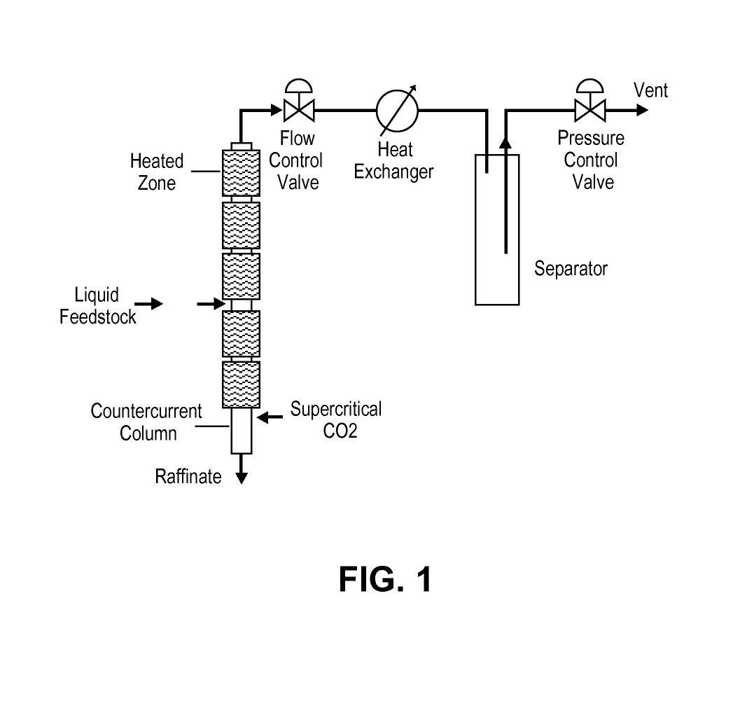

FIG. 2 illustrates a detailed flow diagram of the countercurrent column process.

FIG. 3 illustrates a flow diagram for a batch continuous process operating in cascade mode.

### DETAILED DESCRIPTION

1. Introduction

The present invention provides methods of extracting lipids and carotenes from carrot feedstock using supercritical carbon dioxide. Also provided are carrot raffinate and carrot fiber product compositions produced by the present methods. The methods use water-saturated carrot feedstock (e.g., carrot pomace, carrot mash, carrot puree, etc.) in a slurry. The carrot feedstock used for extraction is not dried or subject to freeze-drying. No other co-solvents are required in the present extraction methods. The extraction methods can be carried out using batch processing or countercurrent column processing.

Extraction of lipid and carotenes from water-saturated carrot feedstock provides for an economically feasible and efficient system of extraction. Supercritical carbon dioxide is sufficiently hydrophobic to extract lipids and carotenes without additional organic co-solvents. Extracting lipids and carotenes from water-saturated carrot feedstock provides a carrot raffinate that is ready for consumption by humans, substantially fat-free with good organoleptic properties, and free of caustic or other undesirable substances (e.g., one or more bleaching agents (e.g., a chlorine bleach, a peroxide), organic solvents, oils, added sugars).

When extracting using a countercurrent column process, the present methods extract lipids and carotenes from carrot feedstock with unexpected efficiency, producing substantially lipid-free, carotene-free carrot raffinate in under 30 minutes. Surprisingly, using the countercurrent column processes of the present invention under high pressure conditions, an unprecedented 52% SCCO₂ solvent extraction of total carotenes in six feet of column length can be reliably achieved. By comparison, using previously known methods, a typical level of extraction would be between 3-5% for the same length of column.

2. Methods

a. Creating A Water Slurry Of Carrot Feedstock

i. Carrot Feedstock Material

Commercial sources of the carrot material include by-product from a fresh carrot cutting and peeling process (cut-and-peel carrot material), and cut or uncut, peeled or unpeeled, carrots obtained from fresh carrot processing operations (grade-out carrot material). Conventionally, cut-and-peel grade-out carrot material is currently sold as unprocessed animal feed and used as raw material for juice. The carrot feedstock will typically not be frozen and/or dried. The carrot material optionally can be frozen before processing.

Carrot feedstock material is produced according to methods well known in the art. Briefly, carrot source material (e.g., cut and peeled grade-out, mashed carrot material, raw carrots, raw cut carrots, peelings and mixtures thereof) is cut into about two inch (2″) pieces or smaller are optionally blanched to above about 165° F. core temperature, ground to less than ¼″ particle size, and optionally heated to above 185° F. (in some embodiments, above 200° F.) to accomplish final enzyme deactivation. The carrot puree is then pressed or centrifuged. The solid residual product from the carrot puree after the carrot juice has been extracted is carrot pomace if blanched, carrot mash if uncooked.

Crude peelings from cut-and-peel carrot material is approximately 2% sugar and 90% total dietary fiber (TDF; as measured by Association of Official Analytical Chemists (AOAC Method 991.43), of which 25% is soluble dietary fiber (SDF; as measured by AOAC Method 991.43), using dry-weight measurement. Grade-out carrot material contains approximately 55% sugar, 32% TDF, and 10% SDF. The large sugar and fiber variance between the two sources is due to the pre-processing inherent in the fresh cutting operation. Cut-and-peel carrot material is the result of a carrot peeling process that uses large amounts of water that leaches out or removes a significant amount of the sugars present in the carrot material, as well as proteins and lipids. Grade-out carrot material has not been through particle size reduction process or a rinsing process. Thus, grade-out carrot material retains most of the properties of unrefined or raw carrots.

The carrot feedstock (e.g., carrot pomace, carrot mash or carrot puree) can be subject to further grinding and a milling screen to produce a feedstock composition of small particle sizes, for example, less than about ⅛ inch (3175 μm) average diameter, for example, about 3500, 3000, 2500, 2000, 1500, 1000, 500, or 250 μm average diameter. The grinder can be, for example, a Rietz® Disintegrator manufactured by Hosokawa Bepex Corporation, Santa Rosa, Calif. Wet grinders are also commercially available from, for example, Brown International, Covina, Calif.

ii. Optional Hot Water Wash

The carrot feedstock (e.g., carrot pomace, carrot mash or carrot puree) can be optionally subjected to a hot water wash. The hot water pre-wash facilitates the availability of lipid and carotenoids for extraction by carbon dioxide. A hot water pre-wash also removes substantial amounts of the sugars that can be a barrier to extraction of carotenoids and lipids. The hot water can have a temperature in the range of about 50-120° C., for example, about 50, 60, 70, 80, 85, 90, 95, 100, 105, 110, 120° C. Subjecting the carrot feedstock to hot water for 30 minutes or less can be sufficient, for example, 20 minutes or 10 minutes. The ratio of hot water to carrot feedstock can be about 5:1 or less (w/w), for example, about 4.5:1, 4.0:1, 3.5:1, 3.0:1, 2.5:1, 2.0:1, 1.5:1, or 1.0:1.

iii. Optional Enzymatic Treatment

The carrot feedstock can be optionally subjected to an enzymatic treatment to render beta-carotenes more available for extraction. In an enzyme treatment, about 0.02 weight percent of an enzyme, for example a pectinase, is added. Enzyme treatment preferably occurs at a temperature of about 50° C. using a pectinase enzyme. Exemplified pectinases include polygalacturonases, pectin methyl esterases and pectin lyases. Pectinases are commercially available from, for example, Novozyme, Bagsvaerd, Denmark.

The carrot feedstock can be exposed to the enzyme for about 3 hours or less, for example, about 2.5 hours, 2.0 hours, 1.5 hours, 1.0 hours, 0.5 hours. In some embodiments, the carrot feedstock is concurrently subjected to hot water and enzyme.

iv. Optional Homogenization

The carrot feedstock can be optionally subjected to homogenization to aid in destruction of the lipid- and carotenoid-bearing cell walls. For example, carrot feedstock can be pumped through a Chemy Burrel or Gaulin homogenizer designed to run between about 1800 to 5000 psi, for cell rupturing or cell lysing, to reduce particle size. Homogenizing the carrot feedstock removes cell wall protection around the lipids and carotenoids, making them more available to the supercritical fluid.

v. Water Slurry of Carrot Feedstock

The carrot feedstock, whether or not subject to an optional pre-treatment, is diluted with water. In some embodiments, the water is de-ionized (DI) and/or distilled. To create the carrot feedstock water slurry, water is added to the carrot feedstock at a ratio of 4:1 (w/w) or less, for example, 4.0:1, 3.5:1, 3.0:1, 2.5:1, 2.0:1, 1.5:1, or 1.0:1. In some embodiments, the water slurry is heated, for example, in the range of about 50-120° C., for example, about 50, 60, 70, 80, 85, 90, 95, 100, 105, 110, 120° C.

In some embodiments, the water slurry comprises carrot feedstock and water, and no other solvents. In some embodiments, the water slurry comprises less than 50% of an organic solvent, for example, about 40%, 30%, 20%, 10%, 5%, or less, of an organic solvent. In some embodiments, the organic solvent is a lower alkyl alcohol, for example, ethanol, propanol, isopropanol, butanol, isobutanol, tert-butanol. In some embodiments, the organic solvent is an oil, for example, a plant or vegetable oil, including but not limited to soybean oil, canola oil, sunflower oil, corn oil, peanut oil, coconut oil. In some embodiments, the water slurry of carrot feedstock is free of organic solvent. In some embodiments, the water slurry of carrot feedstock is free of oil.

The carrot feedstock water slurry is kept in a reservoir that is subject to agitation (i.e., stirring or mixing) to prevent settling.

b. Contacting Water Slurry with Supercritical CO₂

i. Supercritical CO₂

Supercritical carbon dioxide is made by pressurizing supercritical fluid extraction (SFE) grade carbon dioxide gas at a temperature above the critical temperature (31.1° C.) to a pressure above the critical pressure (73.8 bar or 1070 pounds per square inch (psi)). SFE grade carbon dioxide gas is readily commercially available, for example, from Scott Specialty Gases, Plumsteadville, Pa. The carbon dioxide can be pressurized in a gas compressor, for example, a LX Series Low Pressure Gas Compressor by Hydro-Pac, Inc., Fairview, Pa.

ii. Ratio of Solvent to Feedstock

The supercritical carbon dioxide (i.e., solvent) and carrot feedstock (e.g., carrot pomace, carrot mash or carrot puree) can be combined at a ratio between 1.0:1 to 5.0:1 (w/w; mass of SCCO₂ to mass of wet, undiluted carrot feedstock). In some embodiments, the ratio of solvent to feedstock is about 5.0:1 or less, for example, 5.0:1, 4.5:1, 4.0:1, 3.5:1, 3.0:1, 2.5:1, 2.0:1, 1.8:1, 1.5:1, 1.0:1 or 0.5:1 (mass of wet SCCO₂:mass of wet undiluted carrot feedstock). In some embodiments, about 2.0 g to about 3.0 g SCCO₂ per gram carrot feedstock (on a wet basis) is utilized, for example, about 2.0 g, 2.1 g, 2.2 g, 2.3 g, 2.4 g, 2.5 g, 2.6 g, 2.7 g, 2.8 g, 2.9 g, or 3.0 g SCCO₂ per gram carrot feedstock.

iii. Countercurrent Column Process

In one embodiment, the carrot feedstock (e.g., carrot pomace, carrot mash or carrot puree) is contacted with supercritical carbon dioxide in a countercurrent column process. The carrot feedstock water slurry is pumped into the column in one direction (i.e., current) as the continuous phase. The supercritical carbon dioxide is pumped into the column in the opposite direction (i.e., countercurrent) as the discontinuous phase. The supercritical carbon dioxide is not mixed with any other solvent before contacting the carrot feedstock water slurry. In some embodiments, the column is not packed with any stationary phase packing; the water and carrot feedstock in the carrot feedstock water slurry serves as packing and the carbon dioxide is bubbled up through the carrot feedstock water slurry. In some embodiments, a stationary phase packing compatible with the continuous flow of carrot feedstock is used. Carrot feedstock in concentrations of at least about 0.10 g/L to about 0.25 g/L can be included in the carrot feedstock water slurry loaded onto the column, for example, concentrations of about 0.10 g/L, 0.11 g/L, 0.12 g/L, 0.13 g/L, 0.14 g/L, 0.15 g/L, 0.16 g/L, 0.17 g/L, 0.18 g/L, 0.19 g/L, 0.20 g/L, 0.21 g/L, 0.22 g/L, 0.23 g/L, 0.24 g/L or 0.25 g/L. The carrot feedstock can be pumped through the column at a flow rate of at least about 4000 kg/hour (8800 lb/hr).

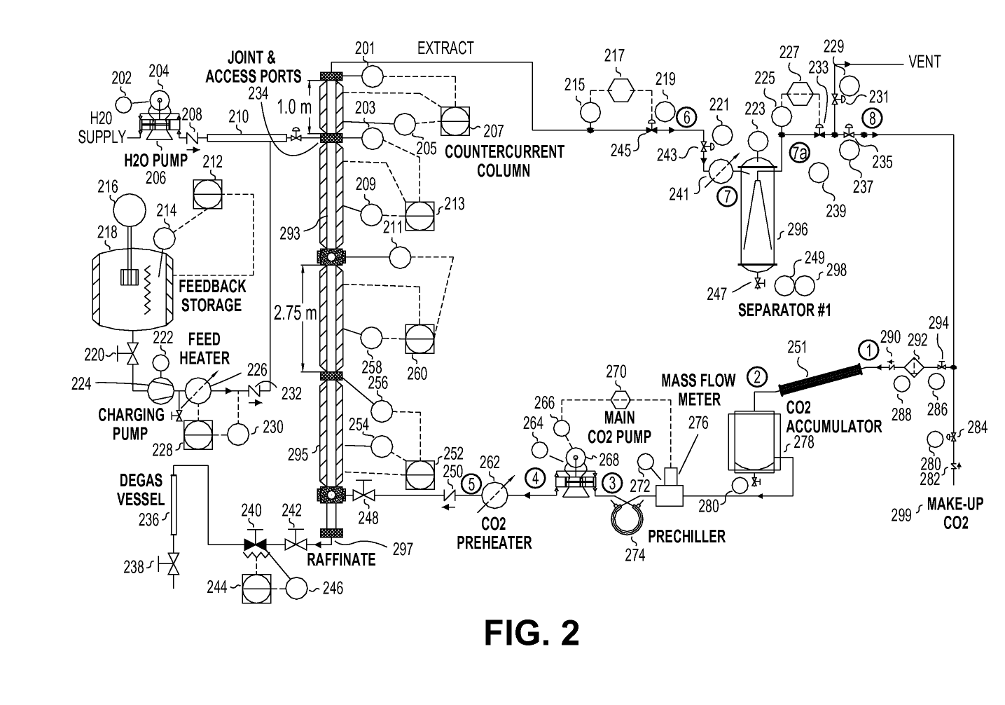

An exemplified countercurrent column system for extraction of lipids and carotenes from carrot feedstock using supercritical carbon dioxide is depicted in FIG. 2. The system encompasses a number of different subsystems to supply feedstock carrot feedstock; supply supercritical carbon dioxide solvent (SCCO₂); dilute and pressurize the feedstock, manage the flow; charge the column with diluted feedstock slurry; maintain the flow, temperature, and pressure within the column; draw raffinate from the column bottom; and perform separation of the extract from the effluent SCCO₂.

SCCO₂ is supplied to the system via a main CO₂ pump. This device preferably will have the capability to pump a flow of at least about 1000 kg/hour and have a discharge pressure of at least about 483 bar (7000 psi), e.g., at least about 550 bar (8000 psi) (an exemplified pump that finds use is a Hydro-Pac LX compressor pump). Suitable pumps can have an electrohydraulic system employing a piston to pressurize the CO₂, a hydraulic cylinder to provide motive pressure, and hydraulic pressure system to supply a driving force to the hydraulic cylinder. The CO₂ pump preferably has a prechiller to ensure that the gas supplied from the condenser and accumulator CO₂ recycle system is liquefied prior to pumping. A preheater between the CO₂ pump and the column regulates the SCCO₂ inlet temperature.

Feedstock (e.g., carrot pomace, carrot mash or carrot puree) material can be supplied to the column in several steps. First, carrot feedstock can be held in a heated feedstock storage vessel. Material can be stored in an undiluted or partially diluted state within this chamber. This vessel can be agitated to maintain the feedstock in a homogenous suspension and heated to bring the feedstock to the desired process temperature. The process temperature will be in the range of about 70° C. to about 140° C., although the process temperature can be varied or uniform in the different storage vessels and along the length of the column, as needed. In some embodiments, the carrot feedstock slurry is heated in the storage vessel to at least about 90° C., for example, about 95° C., 100° C., 105° C., 110° C., 115° C., 120° C., 125° C., 130° C., 135° C. or 140° C. In some embodiments, the carrot feedstock slurry continuous phase is a uniform temperature throughout the length of the column.

The feedstock can be transferred to a vestibule vessel via a low pressure progressive cavity pump (for example, made by Seepex, Bottrop, Germany). This pump fills the vestibule vessel with a charge of feedstock. After this fill cycle, a second compressor pump (for example, a Hydro-Pac compressor pump) applies high pressure water to the rear of the vestibule vessel and raises the pressure in this chamber to the process pressure in the column. The process pressure in the column is at least about 7000 psi (483 bar), e.g., at least about 8000 psi (550 bar), and can be as high as about 10,000 psi (690 bar), for example, about 8500 psi (585 bar), 9000 psi (620 bar), 9500 psi (650 bar). Once the pressure is raised to a level in excess of the pressure within the column, the valve isolating the vestibule vessel and the column can be opened. Additional water can be applied to this chamber to cause the feedstock to flow into the column. After the chamber has been cleared, the remaining water can be drained to enable the vestibule vessel to be refilled with the next cycle of carrot feedstock. The feedstock can be actively heated in the feedstock storage vessel and by a heat exchanger during the charging of the vestibule vessel.

The column can be comprised of several discrete sections (e.g., 4, 5, 6, 7, 8, 9, 10 sections, or more, as needed), each with an equal size internal diameter in the range of about 100-400 mm, usually about 150-300 mm, or 175-225 mm. Commercially available configurations are 185 mm and 222 mm. The internal diameter used will depend on the desired flow capacity. Each of the sections upstream of the junction with the CO₂ intake incorporates a thermal fluid jacket that can be supplied by a pressurized steam heating system so that the temperature in each section can be independently controlled. The sections can be uniform or varying in length, as needed, for example, to provide junctions for entry or exit ports. The column sections can be from about 0.5 to 3.0 meters in length, for example, 0.5, 0.75, 1.0, 1.25, 1.50, 1.75, 2.0, 2.25, 2.5, 2.75, 3.0 meters in length. In some embodiments, a column section is six feet (1.83 meters) in length. The bottom section can act as a liquid reservoir for the accumulation of raffinate during processing. The column, supply piping, and instrumentation can be supported via a framework that provides features so that the column can be vertically aligned. A pressure control valve can be used to regulate the column pressure using feedback from a pressure transducer.

The carrot feedstock is subjected to SCCO₂ extraction conditions for a time period sufficient to extract a desired amount of lipids and carotenes. Using a countercurrent column process, at least about 300-600 kg/hour of carrot feedstock can be processed into substantially lipid-free carrot raffinate in less than 3 hours, for example, in less than 2.5 hours, 2 hours or 1 hour. In some embodiments, at least about 300-600 kg/hour of carrot feedstock can be processed into substantially lipid-free carrot raffinate in less than 30 minutes, for example 20 or 10 minutes. In some embodiments, carrot feedstock can be processed into substantially lipid-free carrot raffinate in less than 1 minute.

c. Separating CO₂ from Feedstock to Yield Carrot Raffinate

The raffinate can be removed from the bottom of the column via one or more valves and a degas vessel. For example, two shutoff valves can be provided on the inlet and outlet of the degas vessel. To remove raffinate from the column, the outlet shutoff valve can be closed and the inlet shutoff valve can be opened. A control valve between the inlet shutoff valve and the degas vessel provides the pressure reduction from pressures up to 690 bar (about 10,000 psi) to ambient pressure. This control valve can be actively heated to compensate for Joule-Thompson cooling during this depressurization. The volume of the degas vessel has been specifically selected to minimize the disturbance of the column pressure during raffinate removal. Once the degas vessel is filled, the inlet valve can be closed and the material can be drained through the outlet valve.

Extract and SCCO₂ can be drawn from the column's top. The extract can be separated from the SCCO₂ stream via a cyclone separator. A cyclone separation system includes a heat exchanger, a flow shutoff valve, and a control valve. The shutoff valve can be used during initial system pressurization. The control valve regulates the separation vessel pressure. The separator can be a modular system that nominally operates at a CO₂ vapor conditions in the range of 60 to 70 bar (870 to 1015 psi).

A countercurrent column system can be monitored by a computerized supervisory control and data acquisition (DAQ) system. This system enables the operator to control SCCO₂ flow rate, the water charging rate, the feedstock fill rate, vestibule charging pressure, the temperature of the inlet flow streams (SCCO₂ and feedstock), the temperature of each column section, the column pressure, and many other relevant process variables. Process fluid temperature within the column can be monitored via thermocouple sensors installed at each column joint (e.g., Type-T sensors). The DAQ system monitors the mass flow of feedstock into the system. A CO₂ mass flow transmitter (e.g., Coriolis) monitors the CO₂ pump rate. Data from the process can be shown via an on-screen trend and is stored in a data file for long-term analysis (e.g., Excel).

With increasing column length, greater amounts of lipid and carotenes can be extracted. The amount of lipids and carotenes that can be extracted from the carrot feedstock using the present supercritical CO₂-countercurrent extraction process can be extrapolated for longer column lengths based on experimental data demonstrated for shorter column lengths using the following equations. For each column length, % Lipid(i)=% Lipid(i−1)*(1−LipidReduced), where Lipid(i) is the concentration at the end of the length and Lipid(i−1) is the concentration at the beginning of the unit column length section. Further, % BetaCarotene(i)=% BetaCarotene(i−1)*(1-BetaReduced), where BetaCarotene(i) is the concentration at the end of the length and BetaCarotene(i−1) is the concentration at the beginning of the unit column length section. Applying these extrapolation equations, the present methods allow for at least a 99% reduction in lipid content and at least a 92% reduction in betacarotene content from the carrot feedstock over a column length of about 60 feet. See, Table 1.

TABLE 1

| | | Lipid | Betacarotene | | |
|---|---|---|---|---|---|
| | | Concentration as | Concentration as | | |
| Length | | a percentage of | a percentage of | | |
| of | Unit | carrot pomace | carrot pomace | Percent | Percent |
| column | Length | feedstock on a dry | feedstock on a dry | Reduction | Reduction in |
| (feet) | (i) | weight basis | weight basis | in Lipid | Betacarotene |
| 0 | 0 | 100.00% | 100.0% | 0 | 0 |
| 6* | 1 | 60.90% | 77.5% | 39.1% | 22.5% |
| 12 | 2 | 37.09% | 60.1% | 62.9% | 39.9% |
| 18 | 3 | 22.59% | 46.5% | 77.4% | 53.5% |
| 24 | 4 | 13.76% | 36.1% | 86.2% | 63.9% |
| 30 | 5 | 8.38% | 28.0% | 91.6% | 72.0% |
| 36 | 6 | 5.10% | 21.7% | 94.9% | 78.3% |
| 42 | 7 | 3.11% | 16.8% | 96.9% | 83.2% |
| 48 | 8 | 1.89% | 13.0% | 98.1% | 87.0% |
| 54 | 9 | 1.15% | 10.1% | 98.8% | 89.9% |
| 60 | 10 | 0.70% | 7.8% | 99.3% | 92.2% |

*experimentally determined

d. Batch Process

The steps of contacting the carrot feedstock water slurry with supercritical carbon dioxide and then separating the raffinate from the CO₂ can be carried out in a single container or in a sequence of multiple containers (e.g., batch process). Carrot feedstock can be diluted with water, as described above, in a single container. In some embodiments, the carrot feedstock can be diluted in water and up to 50% of a lower alkyl alcohol in water. For example, the carrot feedstock can be diluted in an aqueous solution containing about 10%, 20%, 25%, 30%, 35%, 40%, 45% of a lower alkyl alcohol. The lower alkyl alcohol can be, for example, ethanol, propanol, isopropanol, butanol, isobutanol, or tert-butanol or another alcohol having 8 or fewer carbons.

Supercritical carbon dioxide can be added at a solvent to feedstock ratio of 5.0:1 (w/w) or less (e.g., from about 1.0:1 to about 5.0:1), as described above, and then the container can be pressurized to at least about 7000 pst, e.g., at least about 8000 psi, and heated to at least 70° C., for example, 70-120° C., as described above. The feedstock can be subject to the pressurized and heated extraction conditions for about 0.5 to 4.0 hours, for example, 0.5, 1.0, 1.5, 2.0, 2.5, 3.0, 3.5, 4.0 hours. The pressure and temperature can be varied or held constant throughout the extraction process, as desired. In some embodiments, the extraction conditions will initially be carried out at a lower pressure, and then the pressure can be raised during the course of the extraction. In some embodiments, the single container is a mixing reservoir that contains a mixing apparatus that agitates the carrot feedstock during the extraction process. Suitable mixers include ribbon mixers, commercially available from, for example, Hayes & Stolz Industrial Mfg., Fort Worth, Tex. An inlet port can provide a constant feed of supercritical CO₂ and an outlet port can constantly remove extracted lipids, carotenes and sugars during the extraction process. When the container is opened after the extraction process, the extract containing lipids, carotenes and sugars can be removed from the top, and the raffinate remains as an extracted slurry on the bottom.

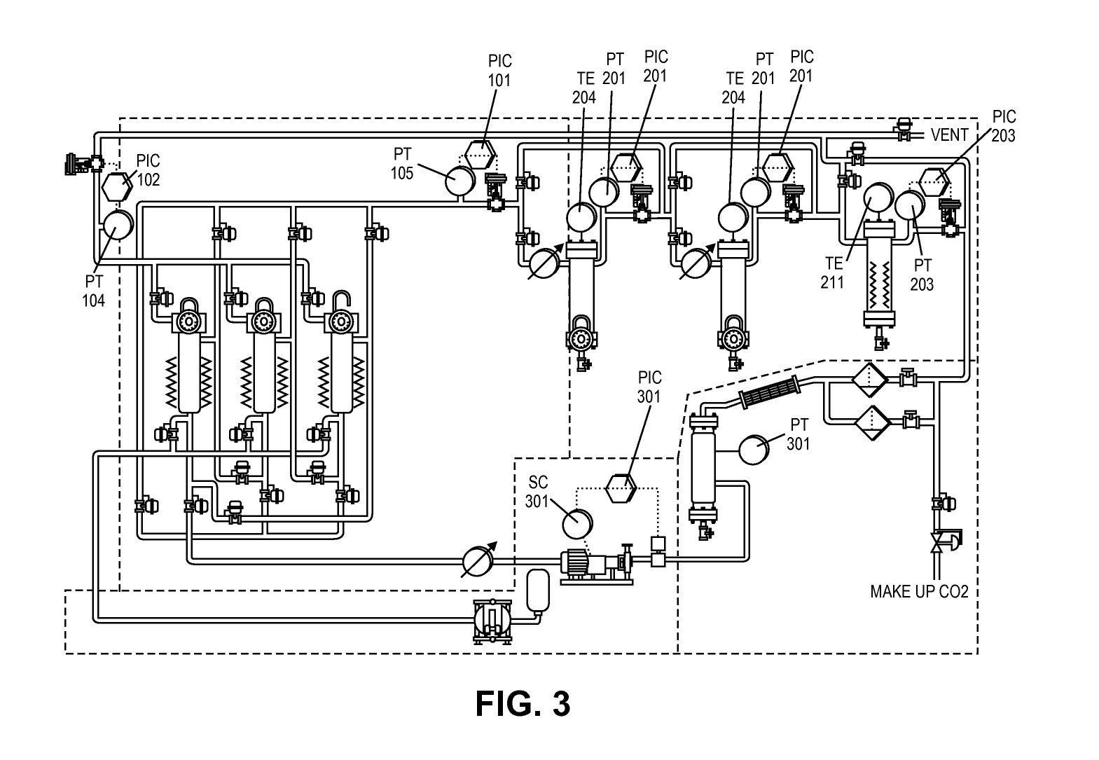

In some embodiments, batch processing is carried out according to a batch continuous process operating in cascade mode. A batch continuous process is illustrated in FIG. 3. As shown in FIG. 3, the green pipework shows the closed cycle flow path for CO₂. The vessels toward the left of the figure are extractors; the three in the upper right are separators. The components in the lower right are a condenser, accumulator, and pump.

The CO₂ circulates in a clockwise direction around the flow cycle. The pump generates high pressure CO₂. The device immediately after the pump is a heat exchanger and heats the process stream to the full extraction (supercritical) conditions. This SCCO₂ flows through extractors 1 (leftmost) and 2 (center) prior to flowing through the pressure reduction valve controlled by PIC101. The CO₂ passes at a lower pressure through separators 1, 2 and 3. As shown, the separation process conditions can be established to achieve fractionation of the different extract streams. This can permit the separation of the betacarotenes from the lipids since the solubilities in SCCO₂ are different.

In another embodiments, the process cycle can employ a cycle separator. In this case, both the carotenes and the lipids can be obtained from a single separator.

In some embodiments, a co-solvent is used. In the lower center of the diagram of FIG. 3, there is a co-solvent pump (located below the main CO₂ pump). This device is used to introduce a co-solvent into the CO₂ stream.

In some embodiments, the water slurry of carrot feedstock is further contacted with an organic co-solvent. In some embodiments, the organic co-solvent is a lower alkyl alcohol, for example, ethanol, propanol, isopropanol, butanol, isobutanol, tert-butanol. In some embodiments, the organic solvent is an oil, for example, a plant or vegetable oil, including but not limited to soybean oil, canola oil, sunflower oil, corn oil, peanut oil, coconut oil. For betacarotenes, one preferred co-solvent is ethanol, although, as discussed above, other lower alkyl alcohols find use.

The co-solvent can be delivered continuously while pumping CO₂, thus establishing a controlled and consistent concentration of co-solvent in CO₂. Alternatively, the co-solvent first can be delivered as a bulk quantity into the vessel and subsequently followed by CO₂. In both cases, the co-solvent enhances the solubility of SCCO₂ for the more polar carotenes, and thereby enables lower pressure and temperature conditions to be employed. The separator conditions can be established so that majority of the co-solvent is deposited in the 3rd separator. This enables most of the co-solvent to be reused. Due to co-solvent vapor pressure, a portion does remain in the gas stream and continues to recirculate with the CO₂ until an equilibrium condition is established.

e. Removal of Sugars

Residual sugars in the carrot raffinate can be removed in a leaching step in which carrot raffinate is diluted with water and mixed to leach or dissolve sugars out of the raffinate until the sugar content is a desired percentage of the total solids content (e.g., less than about 80%, 50%, 30%, 10%, 5%, 2% or 1% of the total solids content, as desired). The leaching step can be accomplished by mixing carrot raffinate and an aqueous solution for a period of time sufficient to leach a desired amount of the residual sugars. The adding and mixing can be accomplished by water injection into washing and transfer conduits and mixing as the material passes though a pump. In some embodiments, at least about equal weight percentages of carrot raffinate and aqueous solution are mixed. In some embodiments, aqueous solution can be added until the sugars content in the transfer conduit is less than about 1% sugars by weight of dry solids, and less than about 0.5% on a dry weight basis. Several leaching cycles can be performed required to reduce the sugars remaining in the raffinate to a desired low level. In some embodiments, the water can be heated.

A separating step is then performed in which the sugar-reduced, lipid-free carrot fiber product is separated from the aqueous solution containing the leached-out sugars. Such separation can be accomplished using hydrosieves, strainers or hydroshears and/or a belt press, but other water separation techniques can be employed. Hydrosieves and hydroshears are commercially available, for example, from IPEC Industries, Burnaby, British Columbia, Canada and Alard Equipment Corporation, Williamson, N.Y. The separation step essentially attempts to bring the solid contents of the carrot fiber product back to the level of about 10% to about 12% by weight of solids. Roughly, therefore, as much aqueous solution with dissolved sugars is removed, as was introduced to enable leaching.

f. Drying

After leaching the sugars from the carrot raffinate, the substantially lipid-free, sugar-reduced carrot fiber product is dried to less than about 10% moisture, for example about 10, 9, 8, 7, 6, 5% moisture. Drying can include an intermediate moisture reduction, which can be accomplished by pumping the mixture of carrot fiber product and residual aqueous solution to a water separation device, for example, a screw press. A water separation device separates the aqueous solution from substantially lipid-free, sugar-reduced carrot fiber product. This separation process can be performed until the solid contents of the puree is about 20% by weight, or higher. Typically, the aqueous solution being pressed off will have a Brix number of 1 or less (most usually a Brix of about 0.4), indicating that very little (below 1% by weight of the solids) of sugar remains in the leached carrot puree after the pressing operation.

It is possible to dry the pressed carrot fiber product in any number of ways, for example, flash drying, oven drying, air drying or spray drying. In some embodiments, the carrot fiber product at 20% solids by weight after pressing is fed to a flash drying apparatus for drying. The powered fiber material which results from flash drying can be used in some applications without further processing. In some embodiments, the flash dried carrot fiber powder is milled while drying continues to reduce the particle size, and then it is sized before an end product of carrot fiber powder is achieved.

g. Reducing Particle Size of Carrot Fiber Product

A milling step is accomplished so that a substantial majority of the particles in the dried powder will pass through a sizing device, for example, a sifter which will pass particles having a size of 250 microns or less. Milled carrot fiber product of the invention will have particle sizes that are on average 250 μm or less, for example, 250, 200, 150 μm or less. Coarse particles that do not pass through the sizing device from the milling step are returned to the mill for further milling.

In some embodiments, a flash drying apparatus for use in producing high water absorption capacity dietary fiber product can be a stream of hot air into which the substantially lipid-free and sugar-reduced carrot fiber product is injected, for example, by dropping through an airlock. The stream of hot air can be confined by a conduit with temperature of the hot air traveling in the conduit being above 260° C., for example, in the range of about 280° C. to about 315° C. An airlock can be at an upstream end of the conduit. The moist carrot material introduced through the airlock into the stream of hot air will cause the air temperature to drop from about 280° C. to about 95° C. in 20 feet, or less at which point the flash dried fiber product is discharged from the downstream end of the flash drying conduit. Optionally, the pressed carrot fiber product also can be passed through a disintegrator (e.g., by Rietz) in advance of the drying step, which will increase the overall fluffiness and texture of the resulting powered fiber product.

The milling step can also be accomplished using a number of different types of conventional milling machines. In one embodiment, milling is accomplished using a turbine mill operating at a tip speed of over 20,000 feet per minute, and most preferably in the range of about 23,000 to 26,000 feet per minute. Suitable turbine mills are commercially available from, for example, Hosokawa Bepex Corp., Santa Rosa, Calif. This high tip speed is very effective in reducing particle size efficiently. As the speed of the turbine mill is reduced, the energy required to effect particle size reduction is greatly increased.

In some embodiments drying is continued during the milling step. This can be accomplished by coupling the downstream end of the flash drying conduit to the turbine mill so that substantially all of the hot air passes through the turbine mill with the flash dried powder.

The dried and ground fiber product powder can then be sent to a sizing device or sifter which can be a 100-mesh screen, or more usually a 200-mesh screen. Sizing sifters are commercially available from Great Western Manufacturing, Inc. of Leavenworth, Kans. Ninety-five percent of the particles must pass the sizing sifter to produce the final product. Coarse fiber material can be returned to the turbine mill. In some embodiments, the particle size of the carrot fiber product is below 100 microns, which can be achieved if a 200-mesh screen is employed as a sizing sifter.

The reduction of the particle size of the refined carrot fiber product has some effect on the water absorption capacity, but is primarily advantageous in terms of producing a fiber product which has good texture characteristics when incorporated into food stuffs, and particularly baked food products.

h. Finished Carrot Fiber Product

The dietary carrot fiber product resulting from the process of the present invention can be used in food applications at a rate of between about 0.5 to about 15% by weight. This rate effectively fortifies the food to maximize health benefits in the diet. However, the amount of carrot fiber used in any given formulation is determined largely by the quantity that can be tolerated from a functional standpoint. That is, the amount of added fiber is generally as high as is acceptable from an organoleptic evaluation of the food. Due to its unique character and water binding capacity, the present dietary carrot fiber can be used in foods at lower rates than other fibers to obtain the same functional results.

In most baked goods, refined carrot fiber can be used at rates between 0.5% to 7% by weight. Baked goods include breads, crackers, muffins, cakes, cookies, rolls, pastries, and other baked products made primarily from flour, starch and other grain-based ingredients.

In coated or breaded foods, carrot fiber can be 5% to 15% of the formulation. The fiber can be blended with the other coating components and used as a blend, or the fiber may be incorporated into the bread or cracker dough prior to cooking, or ground and used as a bread crumb or other particulate matter within the coating or breading mix. The present carrot-based dietary fiber can also be used in food products such as meat products (e.g., sausages, to retain moisture) and to coat cheeses to make them be free-flowing. Cosmetic uses of the present carrot fiber product also can be made.

3. Tests

a. Moisture Content

Moisture content is measured by comparing the weight of carrot product (e.g., feedstock, raffinate or fiber product) before and after drying until all water is evaporated (i.e., bone dry weight). The difference in weight before and after drying the carrot product is the weight of water. The carrot product can be dried using any methods known in the art, for example, by using a vacuum oven.

b. Lipid Content

Lipid content is measured by using gas chromatography (GC) techniques well known in the art. Total fatty acids, mostly triglycerides, in the carrot product are analyzed. The fatty acids may be unsaturated, monounsaturated, or polyunsaturated (e.g., cis-cis). Methods for measuring fatty acid content in foodstuffs using GC are disclosed, for example, in Misir, et al., J Chromatography (1985) 331:141-8; Shantha and Napolitano, J Chromatography (1992) 624:37-51; and Palmquist and Jenkins, J Animal Sci (2003) 81:3250-4. General guidance for carrying out gas chromatography is found in, for example, Kolb and Ettre, Static Headspace-gas Chromatography: Theory And Practice, 2006, John Wiley & Sons; Berezkin and de Zeeuw, Capillary Gas Adsorption Chromatography, 1996, Huthig Verlag; and Modern Practice of Gas Chromatography, Grob and Barry, eds., 2004, E-book, John Wiley & Sons.

The total lipid content in carrot feedstock is compared to the total lipid content in carrot raffinate or in carrot fiber product. The total lipid content in carrot raffinate is compared to the total lipid content in carrot feedstock or carrot fiber product. The total lipid content can also be measured in a carrot product (e.g., feedstock, raffinate or fiber product) independently of comparison with another carrot product. The total lipid content is expressed as a percentage of the total weight of carrot product (e.g., feedstock, raffinate or fiber product) on a dry weight basis.

c. Carotene Content

Total carotenes, including alpha- and beta-carotenes, are measured by homogenizing the carrot product (e.g., feedstock, raffinate or fiber product), subjecting to enzymatic digestion, extracting with tetrahydrofuran, and analyzing using reverse phase high performance liquid chromatography (HPLC) techniques that are known in the art. Methods for measuring carotenes in foodstuffs using HPLC are disclosed, for example, in Dietz, et al., Plant Foods Hum Nutr (1988) 38:333-41; de Padilla, Arch Latinoam Nutr (1996) 46:169-73; Bononi, et al., Anal Bioanal Chem (2002) 372:401-3; and Suries, et al. J Agric Food Chem (2004) 52:3417-21. General guidance for carrying out HPLC is found in, for example, Meyer, Practical High-Performance Liquid Chromatography, 2006, John Wiley & Sons Inc.; and Food Analysis by HPLC, Nollet, ed., 1992, Marcel Dekker. Alpha carotenes or beta carotenes can also be individually measured. In some embodiments, all trans beta carotene or cis beta carotene are individually measured.

The total carotene content in carrot feedstock is compared to the total carotene content in carrot raffinate or in carrot fiber product. The total carotene content in carrot raffinate is compared to the total carotene content in carrot feedstock or carrot fiber product. The total carotene content can also be measured in a carrot product (e.g., feedstock, raffinate or fiber product) independently of comparison with another carrot product. The total carotene content is expressed as a percentage of the total weight of carrot product (e.g., feedstock, raffinate or fiber product) on a dry weight basis.

d. Carbohydrates

Total carbohydrates, mostly in the form of sugars (e.g., sucrose, fructose and glucose), are measured using HPLC techniques known in the art. Methods for measuring carbohydrates in foodstuffs using HPLC are disclosed, for example, in Englyst, et al., Analyst (1994) 119:1497-509; Stober, et al., J Agric Food Chem (2004) 52:2137-46; Lilla, et al., J AOAC Int (2005) 88:714-9; Eberendu, et al., J AOAC Int (2005) 88:998-1007. General guidance for measuring carbohydrates using HPLC is found, for example, in Carbohydrate Analysis: High Performance Liquid Chromatography and Capillary Electrophoresis, Rassi, ed., 1994, Elsevier Science Ltd.

The total carbohydrate (sugar) content in carrot feedstock is compared to the total carbohydrate content in carrot raffinate or in carrot fiber product. The total carbohydrate content in carrot raffinate is compared to the total carbohydrate content in carrot fiber product. The total carbohydrate content can also be measured in a carrot product (e.g., feedstock, raffinate or fiber product) independently of comparison with another carrot product. The total carbohydrate content is expressed as a percentage of the total weight of carrot product (e.g., feedstock, raffinate or fiber product) on a dry weight basis.

e. Color

Color of carrot product solids (e.g., feedstock, raffinate, fiber product) is quantified using a calorimeter and techniques known in the art. See, for example, F. J. Francis and F. M. Clydesdale, Food Colorimetry: Theory and Applications (Westport, Conn.: The AVI Publishing Company, Inc., 1975); Hunter, The Measurement of Appearance (New York: John Wiley & Sons, Inc. 1975) and American Society for Testing and Materials (ASTM) Standards on Color and Appearance Measurement (ASTM Intl, 2000). Colorimeters are commercially available from, for example, Hunter Lab, Reston, Va. (on the Worldwide Web at hunterlab.com), Lumetron and Minolta.

Three parameters are used to describe color: hue, saturation, and lightness (L). Hue is the attribute by which a color is identified as red, yellow, green, etc. Saturation is the proportion of chromatic content in the total perception; it is also the degree of difference from the neutral or gray of the same lightness value. Lightness is the apparent proportion of incident light reflected or transmitted by the object on a scale of white or colorless (L=100), to black (L=0). An “a” value describes the amount of red verses green color with 0 being gray. A “b” value describes the amount of yellow verses blue color with 0 being gray. Taken together, the a and b values describe the hue and saturation of the color.

Color of carrot feedstock is compared to the color of carrot raffinate or of carrot fiber product. The color of carrot raffinate is compared to the color of carrot feedstock or of carrot fiber product. The color of carrot fiber product is compared to the color of carrot feedstock or of carrot raffinate. The color of a carrot product (e.g., feedstock, raffinate or fiber product) can also be measured independently of comparison with another carrot product. The quantified color of a carrot product is expressed as a unitary value on a calibrated color scale (e.g., as an L*a*b value, or just an L value).

### EXAMPLES

The following examples are offered to illustrate, but not to limit the claimed invention.

### Example 1

### Carrot Pomace Processing with 3:1 Dilution in Water and 2 Hours Extraction

Feedstock was prepared to a ratio of 3:1 (water:carrot) by mixing 980 g of frozen carrot feedstock and 2940 g of deionized (DI) water (17.6 megohm-cm). The resulting combination was agitated and warmed to room temperature. The resulting feedstock and water mixture was both a slurry and the feedstock for the process. This slurry was actively stirred throughout the experiment. The mixture was fed into the process column via a slurry pump.

A high pressure (690 bar rated) extraction column was employed to enable the countercurrent contact between the feedstock and supercritical CO₂. The contacting distance between the injection point of the feedstock and the CO₂ injection was 6 feet (183 cm). Prior to initiating the process, the column was filled with approximately 1.6 L of DI water and sealed. No conventional column packing (i.e., stationary phase, adsorbent) was employed in this run; the carrot feedstock and water slurry served as the packing. The temperature in the column was set at 125° C. in all the sections. The oven chamber was set at 135° C. in order to preheat the CO₂ entering the column. The CO₂ supply pressure was 650 bar. The extract discharge valve was set at 140° C.

The feedstock was fed into the column at an average of rate of approximately 10 ml/min; the extract (top) was kept at 2.5 LPM. The bottom valve was opened every five minutes and a volume of liquid equal to the volume fed in that period was drawn from the column. An average flow rate of approximately 10 ml/min was maintained at the column bottom.

Every ten minutes, readings were taken of the pressure inside the column, in the CO₂ pump and the slurry pump, also of the temperatures at the center of the column in each one of the column joints, as well as the temperatures in the walls for each one of the four sections. Finally the temperatures of CO₂ entering and exiting the column were also read and recorded. The column was operated in the manner described above for 2 hours.

### Results:

During the first 140 minutes the raffinate changed color steadily from bright orange to dark brown. The extract was observed to have a yellow color and no water was collected in it. The raffinate was tested for lipids and carotenoids. Since total extraction was not expected in a column 6 feet in length, the apparatus was used to evaluate the reduction in the lipid and carotenoid content in the raffinate as compared to the feedstock material. The raffinate has high moisture content due to the water present in the carrot feedstock and the added water.

The moisture content of the raffinate was determined loss in weight following drying in a vacuum oven. Lipid content was measured through gas chromatograph analysis of fatty acids. Beta-carotene content was evaluated by homogenizing the raffinate, subjecting to enzymatic digestion, extracting with tetrahydrofuran, and analyzing using Reverse Phase High Performance Liquid Chromotography (HPLC). Fatty acid content and total Beta-carotene content of the raffinate were 84.3% and 53.7%, respectively, of the feedstock material (i.e., carrot feedstock); a 15.7% reduction in fatty acid content and a 46.3% reduction in beta-carotene content. The values were computed by comparison of the dry weight content of fatty acid and beta-carotene in the feedstock material and in the raffinate.

In other embodiments of the invention, the column length is increased to between about 36 and 60 feet to achieve further reduction of lipid content and carotenoids in the resulting product. In this process, both the lipid and beta-carotene content of the raffinate are reduced to less than 5% of the feedstock pomace; a 95+% reduction in fatty acid content and a 95+% reduction in beta-carotene content.

### Example 2

### Carrot Pomace Processing with 4:1 Dilution in Water and 6 Hours Extraction

Feedstock was prepared to a ratio of 4:1 (water:carrot by wt.) by mixing 960 g of carrot fiber and 3840 g of DI water (17.6 megohm-cm). The resulting combination was agitated and warmed to room temperature. The resulting pomace and water mixture was both a slurry and the feedstock for the process. This slurry was actively stirred throughout the experiment. The mixture was fed into the process column via a slurry pump.

A high pressure (690 bar rated) extraction column was employed to enable the countercurrent contact between the feedstock and supercritical CO₂. The contacting distance between the injection point of the feedstock and the CO₂ injection was 6 feet (183 cm). Prior to initiating the process, the column was filled with approximately 1.4 L of DI water and sealed. No conventional column packing was employed in this run. The temperature in the column was set at 120° C. in all the sections except for zone 4 (feed point) which was maintained at a temperature of 100° C. The oven chamber was set at 135° C. in order to preheat the CO₂ entering the column. The CO₂ supply pressure was 650 bar. The extract discharge valve was set at 140° C.

The column was operated in the manner described above for 3.5 hours. Steady state was estimated to have been reached after 2 hours and 20 minutes when a volume of 1450 ml had been displaced. After 3.5 hours an additional 179.2 g of carrot pomace were added to the feedstock funnel increasing the feedstock concentration to a ratio of water to carrot equal to 3:1. After this, the column was operated for 2.5 hours until no fiber was coming to the bottom.

### Results:

During the first 140 minutes the raffinate changed color steadily from bright orange to dark brown, after that no change in color was observed. The extract was observed to have a yellow color and no water was collected in it. After 140 minutes, no noticeable change in color was observed in the raffinate. Raffinate from the process time interval from 120 minutes to 210 minutes was collected and analyzed. Fatty acid content and total Beta-carotene content of the raffinate were 77.3% and 86.9%, respectively, of the feedstock material; a 22.7% reduction in fatty acid content and a 13.1% reduction in beta-carotene content. The values were computed by comparison of the dry weight content of fatty acid and beta-carotene in the feedstock material and in the raffinate.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method of manufacturing a substantially lipid-free carrot raffinate comprising the steps of:
a) creating a water slurry of carrot feedstock;
b) contacting the water slurry with supercritical CO₂ at a temperature of between 70-120° C. and pressure in excess of 7000 psi (483 bar), thereby extracting lipids and carotenes from the carrot feedstock; and
c) separating the CO₂ from the feedstock to yield a substantially lipid-free carrot raffinate.

2. The method of claim 1, wherein the carrot feedstock is carrot pomace.

3. The method of claim 1, wherein the carrot feedstock is carrot puree.

4. The method of claim 1, wherein at least 45% of lipids are extracted from the carrot feedstock.

5. The method of claim 1, wherein the raffinate contains less than 5% lipids on a dry weight basis.

6. The method of claim 1, wherein at least 50% of carotenes are extracted from the carrot feedstock.

7. The method of claim 1, wherein the raffinate contains less than 10% carotenes on a dry weight basis.

8. The method of claim 1, further comprising after step c) the step of removing sugars from the raffinate, thereby producing a substantially lipid-free and sugar-reduced carrot fiber product.

9. The method of claim 8, further comprising the step of drying to less than about 15% moisture.

10. The method of claim 9, further comprising the step of reducing the particle size of the carrot fiber product to less than about 250 μm.

11. The method of claim 1, further comprising before step a) the step of pre-washing the carrot feedstock with water heated to least about 40° C.

12. The method of claim 1, further comprising before step a) the step of pre-treating the carrot feedstock with an enzyme.

13. The method of claim 12, wherein the enzyme is a pectinase.

14. The method of claim 1, wherein the carrot feedstock in the water slurry of step a) is comprised of carrot particles less than about 500 μm.

15. The method of claim 1, wherein the water slurry of carrot feedstock of step a) comprises a ratio of water to carrot feedstock of about 3:1 or less.

16. The method of claim 1, wherein the water slurry of carrot feedstock is heated to at least about 50° C.

17. The method of claim 1, wherein the contacting step b) is carried out in a batch process.

18. The method of claim 1, wherein the contacting step b) is carried out in a batch-continuous process.

19. The method of claim 1, wherein the contacting step b) is carried out in a countercurrent column process.

20. The method of claim 19, wherein the countercurrent column has no stationary phase packing.

21. The method of claim 19, wherein the column is about 6-100 feet in length.

22. The method of claim 19, wherein the lipids and carotenes are extracted in less than about 10 minutes.

23. The method of claim 1, wherein the ratio of supercritical CO₂ solvent to carrot feedstock is about 5:1 or less.

24. The method of claim 1, wherein the water slurry of carrot feedstock is further contacted with an organic solvent.

25. A counter-current column comprising a continuous phase of carrot feedstock and a discontinuous phase of supercritical carbon dioxide.

26. The column of claim 25, wherein the column has no stationary phase.

27. The column of claim 25, wherein the carrot feedstock is in a water slurry.
